(19) United States
(12) Patent Application Publication
(10) Pub. No.: US 2022/0018319 A1
(43) Pub. Date: Jan. 20, 2022

(54) FUEL SUPPLY DEVICE

(71) Applicant: NIKKI CO., LTD., Kanagawa-ken (JP)

(72) Inventor: Yukinori Suematsu, Kanagawa-ken (JP)

(21) Appl. No.: 17/376,122

(22) Filed: Jul. 14, 2021

(30) Foreign Application Priority Data
Jul. 15, 2020 (JP) 2020-121617

(51) Int. Cl. F02M 37/00; B60K 15/03

(52) U.S. Cl. CPC F02M 37/0052; B60K 2015/03243; B60K 15/03

(57) ABSTRACT

A fuel supply device may include a housing, a fuel pump, a regulator, and an atmosphere communication passage. The housing may include a housing main body in which a fuel storage tank is formed and a lid body that covers an opening part of the housing main body. The fuel pump may feed a fuel that is stored. The regulator may return a surplus fuel to the fuel storage tank while regulating a pressure of the fuel. The atmosphere communication passage may penetrate through from a bottom surface side to an upper surface side of the lid body to communicate an upper space of the fuel storage tank with an outside. A center line of an inlet-passage vertically disposed and a center line of an outlet-side passage vertically disposed may be shifted from each other by a predetermined distance in a horizontal direction.

### CROSS-REFERENCE TO RELATED APPLICATION

This application claims priority to Japanese Application No. JP 2020-121617 file on Jul. 15, 2020, the contents of which are hereby incorporated by reference in its entirety.

### TECHNICAL FIELD

The present invention relates to a fuel supply device that is disposed on a way of a fuel supply passage for connecting an engine and a fuel tank, and in particular relates to a fuel supply device that includes a fuel storage tank in addition to a fuel pump and a regulator and that functions as a reservoir.

### RELATED ART

In supplying fuel stored in a fuel tank to an engine, in order to stably supply the fuel without interruption even at sudden acceleration or sudden deceleration, a fuel supply device that includes a fuel storage tank in addition to a fuel pump and a regulator and that functions as a reservoir is disposed on a way of a fuel supply passage from the fuel tank to the engine, in many cases.

As such a fuel supply device, there is a known structure of the fuel supply device including a fuel pump for feeding the fuel stored in the fuel storage tank also serving as a reservoir tank to the engine, a float and an opening and closing valve for maintaining a liquid surface of the stored fuel at a predetermined level, and a regulator for regulating pressure of the fuel to be fed, so that surplus fuel generated by the pressure regulation is returned to the fuel storage tank from a return port provided at a lower part of the regulator, as described in, for example, JP 2008-297941 A.

In the fuel supply device of this type, by the way, when the surplus fuel flows down to the fuel storage tank from the return port or when external vibrations are applied to the fuel supply device, the liquid surface of the fuel storage tank swings largely with waves.

Hence, there is a problem that the fuel leaks to the outside through an atmosphere communication passage that is opened above the liquid surface.

To address such a problem, the inventor and the applicant of the present invention have already proposed in JP 2018-105129 A, as shown in FIG. 4, a fuel supply device 1B configured to restrict swinging of the liquid surface above the liquid surface, by using a lid body 3B constituting an upper part of a housing and serving as a structure of filling most of an opening part of a fuel pump 23 except for an upper end side, in the opening part of a fuel storage tank 2b of a housing main body 2B in which a float 24 is internally disposed.

With such a configuration, a swinging range of the liquid surface is restricted, so that the fuel leakage to the outside through an atmosphere communication passage 36 can be reduced.

In the typical fuel supply device 1B, however, an inlet-side passage 36a and an outlet-side passage port 36b of the atmosphere communication passage 36 linearly communicate with each other with the same thickness as illustrated in the drawing.

Hence, even with the configuration of buffering the swinging of the liquid surface of the fuel by using the bottom surface of the lid body 3B that closes the opening part of the fuel storage tank 2b, there remains a problem that the fuel leakage cannot be sufficiently reduced when large vibrations are applied to the fuel supply device 1B.

Therefore, as indicated by a broken line in FIG. 4, there is also a known method for reducing the swinging range of the liquid surface at the time of vibration to be small by disposing a baffle plate 39 made of a lid-shaped member above the liquid surface.

However, the addition of a new component to the typical structure in this manner is likely to be disadvantageous in terms of manufacturing cost, and is also likely to cause a failure.

### SUMMARY

The present invention is intended to address the above-described problems, and has an object to provide a fuel supply device that is disposed on a way of a fuel supply passage to an engine and that also serves as a reservoir, so as to reduce fuel leakage to the outside through an atmosphere communication passage due to a vibration applied to the fuel supply device.

### BACKGROUND

According to the present invention that has been made to address the above problems, a fuel supply device that is disposed on a way of a fuel supply passage from a fuel tank to an engine to supply a fuel that has been regulated to a predetermined pressure to the engine, includes: a housing including a housing main body in which a fuel storage tank also serving as a reservoir tank is formed, and a lid body that covers an opening part of the housing main body; a fuel pump that feeds a fuel that is stored; a regulator that returns a surplus fuel to the fuel storage tank while regulating a pressure of the fuel; and an atmosphere communication passage that penetrates through from a bottom surface side to an upper surface side of the lid body to communicate an upper space of the fuel storage tank with an outside, the fuel pump, the regulator, and the atmosphere communication passage being disposed in an inside of the housing, in which in the atmosphere communication passage, a center line of an inlet-side passage vertically disposed and a center line of an outlet-side passage vertically disposed are shifted from each other by a predetermined distance in a horizontal direction, and an intermediate portion bends.

In this manner, by adopting the configuration in which the atmosphere communication passage that is linearly formed in a vertical direction in general is shifted in a horizontal direction between an inlet side of a lower part and an outlet side of an upper part, a state in which the fuel hardly flows in the atmosphere communication passage is ensured.

Therefore, minimization of the fuel leakage is enabled.

In addition, in the above fuel supply device, the atmosphere communication passage is connected with a regulator back pressure chamber formed in the lid body at the intermediate portion of the atmosphere communication passage to share a space with the regulator back pressure chamber, and the intermediate portion that bends is configured by entering the outlet-side passage from the inlet-side passage through the regulator back pressure chamber.

In such a case, while the passage of the bending part is elongated, the passage volume can be ensured largely, accordingly.

Hence, the fuel that has entered the atmosphere communication passage further hardly reaches the outside.

Further, in the present invention, in a case where an opening area of the inlet-side passage is larger than an opening area of the outlet-side passage in the atmosphere communication passage, the fuel that has once entered the atmosphere communication passage easily returns to the fuel storage tank side.

According to the present invention, the state in which the fuel hardly flows in the atmosphere communication passage is ensured, and the fuel leakage can be minimized.

### BRIEF DESCRIPTION OF DRAWINGS

FIG. 1 is a longitudinal sectional view of a fuel supply device according to an embodiment of the present invention;

FIG. 2 is an enlarged partial view showing details of an internal structure of a lid body in the fuel supply device of FIG. 1;

FIG. 3 is a partially cutout perspective view for describing a detailed configuration of the lid body in FIG. 2; and

FIG. 4 is a longitudinal sectional view of a typical fuel supply device.

### DETAILED DESCRIPTION

Hereinafter, embodiments of the present invention will be described with reference to the drawings.

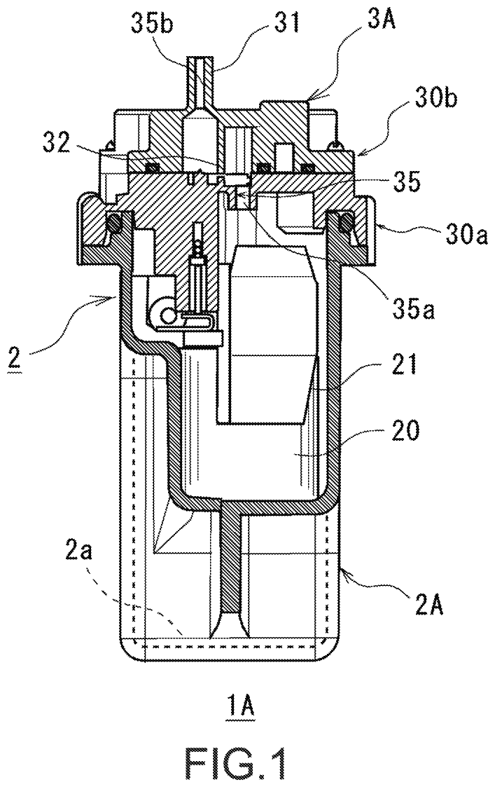

FIG. 1 is a longitudinal sectional view of a fuel supply device in a preferred embodiment of the present invention.

A fuel supply device 1A includes a fuel storage tank 2a, a fuel pump 20, a float 21, and a regulator (not shown) in an inside of a housing 2, and is disposed on a way of a fuel supply passage between a fuel tank, not shown, and an engine, so that the fuel supply device 1A functions as a fuel supply unit and also functions as a reservoir.

Even at sudden acceleration or sudden deceleration of a vehicle on which the fuel supply device 1A is mounted, it is excellent that the fuel can be stably supplied without interruption.

The fuel supply device 1A includes a housing main body 2A in the inside of which the fuel storage tank 2a also functioning as a reservoir tank is formed, and a lid body 3A disposed to close an opening part of the housing main body 2A.

The housing main body 2A and the lid body 3A constitute the housing 2, which is hollow. In addition, a regulator, not shown, is disposed on the lid body 3A, and an atmosphere communication pipe 31, through which an atmosphere communication passage 35 for communicating the inside and the outside of the housing 2 passes, protrudes on the upper surface side of the lid body 3A.

On the other hand, on the housing main body 2A side constituting the fuel storage tank 2a, there are disposed an electric fuel pump (a turbine vane pump) 20 that pressure-feeds the stored fuel, and a fuel storage amount adjusting unit that maintains the liquid surface of the stored fuel at a constant level while opening and closing a valve on a base end side of a valve lever having the float 21 on a tip end side in a cantilever manner.

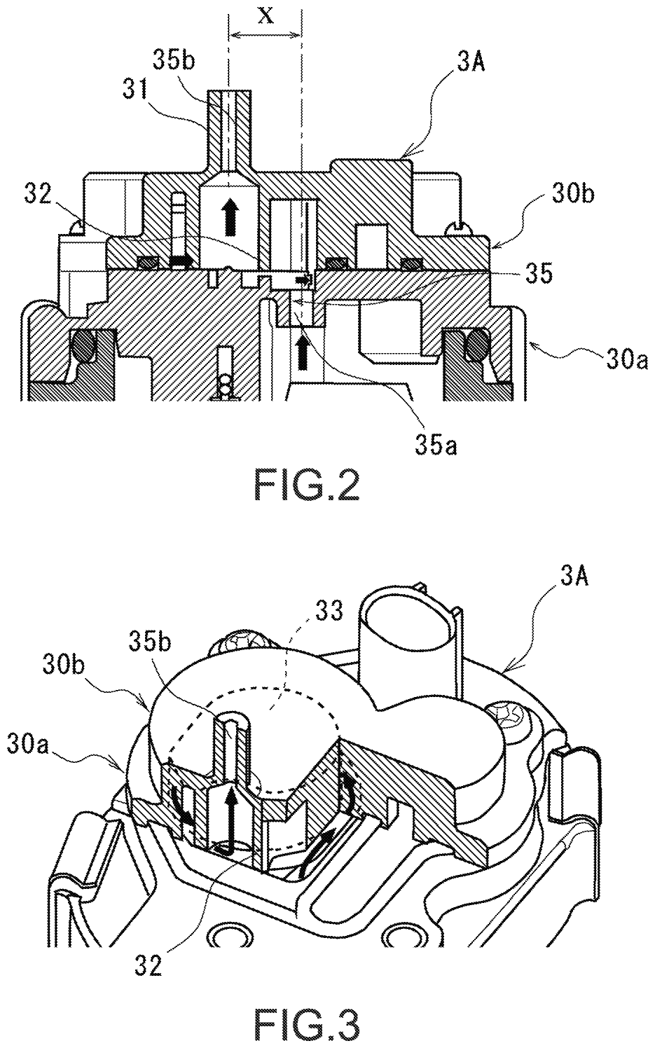

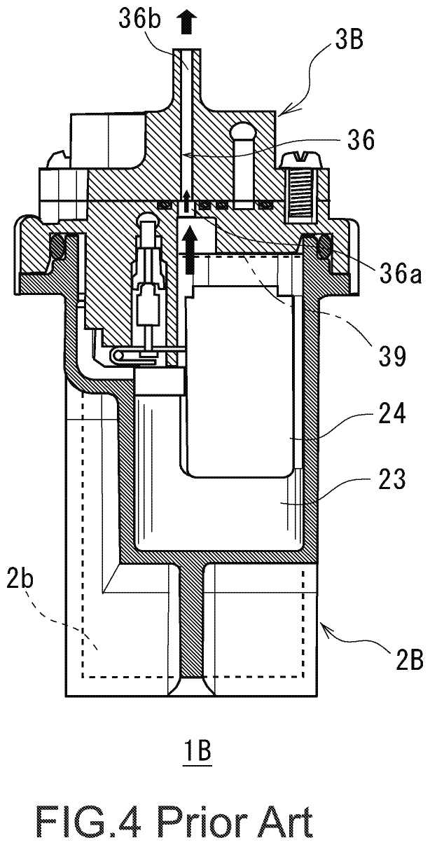

FIG. 2 is an enlarged view of the lid body 3A of FIG. 1.

As described above, the lid body 3A is a lid-shaped member having a structure that covers most of the opening part of the housing main body 2A except for an upper end side and a fuel introduction passage of the fuel pump 3.

The atmosphere communication passage 35 is formed to penetrate through from the bottom surface side to the upper surface side of the lid body 3A to communicate an upper space of the fuel storage tank 2a with the outside, and the center lines of an inlet-side passage 35a disposed in a vertical direction and an outlet-side passage 35b disposed in the vertical direction are arranged to be shifted from each other by a predetermined distance in a horizontal direction, and in addition, the path of an intermediate portion of the atmosphere communication passage 35 bends.

That is, the lid body 3A has a two-layer structure including a lower member 30a in which the inlet-side passage 35a is formed and an upper member 30b in which the outlet-side passage 35b is formed.

The center lines of the inlet-side passage 35a and the outlet-side passage 35b are respectively arranged at positions shifted from each other by a distance X in the horizontal direction, as shown, to constitute a bending path.

The fuel that has entered the inlet-side passage 35a hardly flows in the atmosphere communication passage 35, so that the fuel leakage is minimized.

In addition, in the present embodiment, the atmosphere communication passage 35 has a configuration in which an opening area of the inlet-side passage 35a is larger (two to three times in the present example) than an opening area of the outlet-side passage 35b (a tapered structure).

Therefore, the fuel that has once entered and risen in the atmosphere communication passage 35 easily returns to the fuel storage tank 2a side.

Further, in the present embodiment, as shown in FIG. 3, the atmosphere communication passage 35 is connected with a regulator back pressure chamber 33 formed in the lid body 3A at an intermediate portion of the atmosphere communication passage 35 to share an internal space of the regulator back pressure chamber 33.

A partition wall 32 is formed between the inlet-side passage 35a and the outlet-side passage 35b.

Therefore, by entering the outlet-side passage 35b from the inlet-side passage 35a through the regulator back pressure chamber 33, a long and bending path and a large space are ensured in the atmosphere communication passage 35.

That is, the fuel that has entered the atmosphere communication passage 35 indicated by a thick arrow in the drawing passes along an inner peripheral surface of a peripheral wall formed to have an annular shape, when entering the regulator back pressure chamber 33.

However, even in a case where a part of the fuel reaches below the outlet-side passage 35b, the regulator back pressure chamber 33 has a relatively large volume, and therefore, a large amount of inflow of the fuel and a strong inflow pressure are needed to rise in the outlet-side passage 35b from the regulator back pressure chamber 33 and then exit to the outside. By elongating the path of the bending part in the atmosphere communication passage 35 while ensuring the volume of the atmosphere communication passage 35 to be large in such a manner, the fuel that has entered the atmosphere communication passage 35 hardly reaches the outside.

As described above, with regard to the fuel supply device that is disposed on a way of the fuel supply passage to the engine and that also serves as the reservoir, the fuel leakage to the outside through the atmosphere communication passage is reduced even when vibrations are applied to the fuel supply device.

1. A fuel supply device that is disposed on a way of a fuel supply passage from a fuel tank to an engine to supply a fuel that has been regulated to a predetermined pressure to the engine, the fuel supply device comprising:
a housing including a housing main body in which a fuel storage tank serving as a reservoir tank is formed, and a lid body that covers an opening part of the housing main body;
a fuel pump that feeds a fuel that is stored;
a regulator that returns a surplus fuel to the fuel storage tank while regulating a pressure of the fuel; and
an atmosphere communication passage that penetrates through from a bottom surface side to an upper surface side of the lid body to communicate an upper space of the fuel storage tank with an outside, the fuel pump, the regulator, and the atmosphere communication passage being disposed in an inside of the housing, wherein in the atmosphere communication passage, a center line of an inlet-side passage vertically disposed and a center line of an outlet-side passage vertically disposed are shifted from each other by a predetermined distance in a horizontal direction, and an intermediate portion bends.

2. The fuel supply device according to claim 1, wherein the atmosphere communication passage is connected with a regulator back pressure chamber formed in the lid body at the intermediate portion of the atmosphere communication passage to share a space with the regulator back pressure chamber, and the intermediate portion that bends is configured by entering the outlet-side passage from the inlet-side passage through the regulator back pressure chamber.

3. The fuel supply device according to claim 1, wherein an opening area of the inlet-side passage is larger than an opening area of the outlet-side passage, in the atmosphere communication passage.

4. The fuel supply device according to claim 2, wherein an opening area of the inlet-side passage is larger than an opening area of the outlet-side passage, in the atmosphere communication passage.
